(19) United States
(12) Patent Application Publication
(10) Pub. No.: US 2017/0024125 A1
(43) Pub. Date: Jan. 26, 2017

(54) SELECTIVE TOUCH SCREEN DISABLEMENT FOR USER INTERFACE CONTROL

(71) Applicant: International Business Machines Corporation, Armonk, NY (US)

(72) Inventors: Barton W. Emanuel, Manassas, VA (US); Sarbajit K. Rakshit, Kolkata (IN)

(21) Appl. No.: 14/803,184

(22) Filed: Jul. 20, 2015

(51) Int. Cl. G06F 3/0488; G06F 21/83; G06F 21/32; G06F 3/041; G06F 3/0484

(52) U.S. Cl. CPC G06F 3/04886; G06F 3/0416; G06F 3/04847; G06F 21/32; G06F 21/83

(57) ABSTRACT

Embodiments of the present invention provide for selective touch screen disablement for user interface control of a mobile device. A method for selective screen disablement for user interface control of a mobile device includes defining a portion of a display screen of a computer in memory of the computer, for instance a touch screen display, the portion including one or more user interface controls of a computer program executing in the memory of the computer. The method also includes receiving a user interface event in the display screen in connection with one of the user interface controls of the computer program and determining whether or not the event is associated with the defined portion. Finally, the method includes inhibiting processing of the event in the computer program with respect to a corresponding user interface control in response to a determination that the event is associated with the defined portion.

### BACKGROUND OF THE INVENTION

Field of the Invention

The present invention relates to access and control restrictions in a computing device and more particularly to touch screen management in a computing device.

Description of the Related Art

Access and control in the computing context pertains to the limitation of an end user accessing the control features of a computer program. Those limitations can be imposed programmatically in response to access requests, or through the limitation of controls present in a user interface of the computer program so as to limit the ability of the end user to issue particular requests in the first instance. In either circumstance, the choice as to how to impose access and control limitations occurs at design time when the developer designs the computer program. Once the access and control limitations are imposed at design time, those limitations cannot be changed absent the inclusion in the computer program of a feature allowing the end user to manually specify access and control limitations at run-time.

In this regard, computer programs oftentimes provide for the manual specification of access and control limitations as a menu option for an end user enjoying administrative access to all of the features of a computer program. The manual specification additionally can include different limitations for different end users depending upon the role or identity of the end user. Indeed, different limitations can be imposed based upon the context of the use of the computer program—namely the time at which the computer program is used.

Still, there are times when an ad hoc restriction on the use of a computer program is desired for an application not providing for the manual specification of access and control restrictions. In that circumstance, during run-time it is not possible to impose intra-application limitations on the use of the computer program. Thus, any end user enjoying access to the computer program can direct any operation provided by the computer program including such critical functions as those directed to the irretrievable deletion of data of the computer program.

### BRIEF SUMMARY OF THE INVENTION

Embodiments of the present invention address deficiencies of the art in respect to access and control restrictions in a computing device and provide a novel and non-obvious method, system and computer program product for selective touch screen disablement for user interface control of a mobile device. In an embodiment of the invention, a method for selective screen disablement for user interface control of a mobile device is provided. The method includes defining a portion of a display screen of a computer in memory of the computer, for instance a touch screen display, the portion including one or more user interface controls of a computer program executing in the memory of the computer. The method also includes receiving a user interface event in the display screen in connection with one of the user interface controls of the computer program. The method yet further includes determining whether or not the event is associated with the defined portion. Finally, the method includes inhibiting processing of the event in the computer program with respect to a corresponding one of the user interface controls in response to a determination that the event is associated with the defined portion.

In one aspect of the embodiment, the inhibition of processing is disabled for an authorized end user. In this regard, the inhibition of processing may be disabled for an authorized end user determined based upon facial recognition of the end user. In another aspect of the embodiment, the inhibition of processing is enabled for an unauthorized end user.

In another embodiment of the invention, a data processing system is configured for selective screen disablement for user interface control of a mobile device. The system includes a computer with memory and at least one processor and a display screen coupled to the computer. The system also includes a computer program executing in the memory of the computer. Finally, the system includes a selective screen disablement module executing in the memory of the computer. The module includes program code enabled to defining a portion of the display screen including one or more user interface controls of the computer program, to receive a user interface event in the display screen in connection with one of the user interface controls of the computer program, to determine whether or not the event is associated with the defined portion, and to inhibit processing of the event in the computer program with respect to a corresponding one of the user interface controls in response to a determination that the event is associated with the defined portion.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for selective touch screen disablement for user interface control of a mobile device;

FIG. 2 is a schematic illustration of a data processing system configured for selective touch screen disablement for user interface control of a mobile device; and,

FIG. 3 is a flow chart illustrating a process for selective touch screen disablement for user interface control of a mobile device.

### DETAILED DESCRIPTION OF THE INVENTION

Embodiments of the invention provide for selective touch screen disablement for user interface control of a mobile device. In accordance with an embodiment of the invention, a portion of a display of a computer, such as a touch screen display, that includes one or more user interface controls of a computer program executing in the memory of the computer, is defined in the memory of the computer. Thereafter, screen events associated with the defined portion are not permitted to translate into corresponding selection events for any of the user interface controls of the defined portion. However, those user interface controls not included in the defined portion are not subject to the inhibition of the translation of selection events. In this way, access and control limitations can be placed upon the computer program at run-time without requiring the computer program to include functionality for the manual specification of access and control.

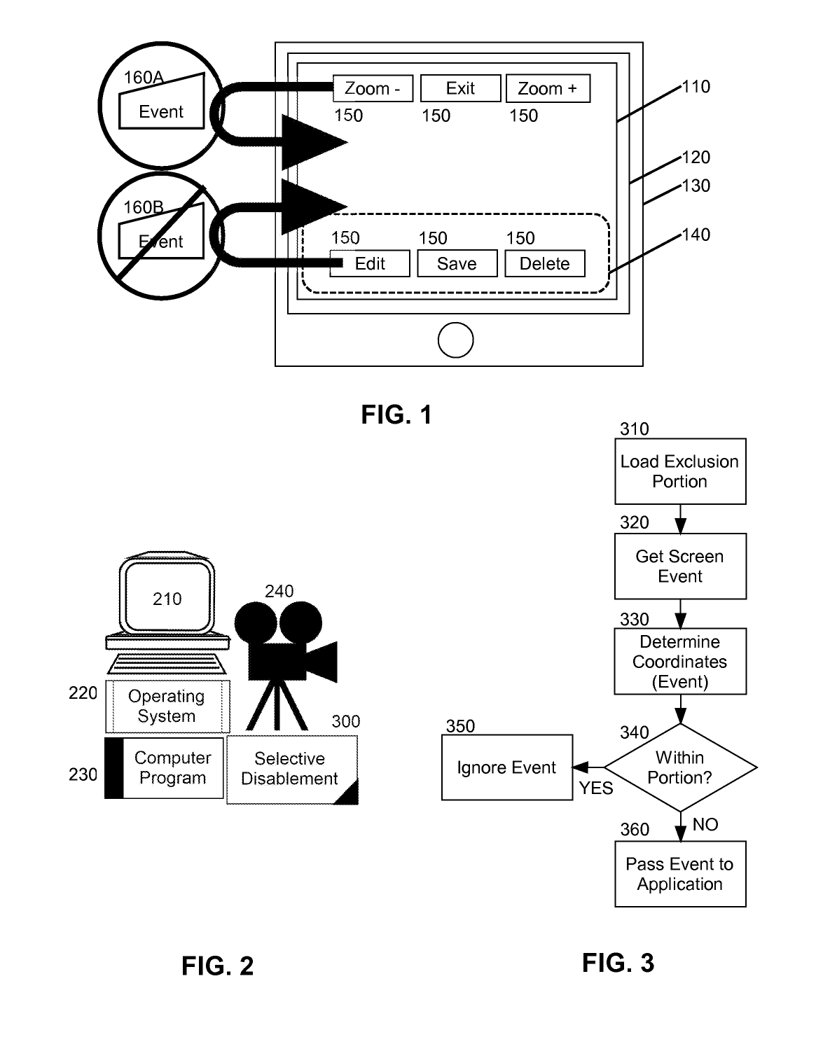

In further illustration, FIG. 1 pictorially shows a process for selective touch screen disablement for user interface control of a mobile device. As shown in FIG. 1, a computing device 130 can include a display screen 120 in which a user interface to a computer program 110 is provided. The user interface to the computer program 110 includes different user interface controls 150 in response to the selection of which different events 160A, 160B are passed to the computer program 110 for processing by the computer program 110. Of note, a display portion 140 of the display screen 120 is selected such that the display portion 140 includes one or more of the user interface controls 150. Thereafter, events 160B occurring in the display screen 120 in association with the display portion 140 are not permitted to be further processed by the computer program 110. Conversely, events 160A occurring in the display screen 120 in association with portions of the display screen 120 not included in the display portion 140 are permitted to be further processed by the computer program 110.

The process described in connection with FIG. 1 is implemented in a data processing system. In further illustration, FIG. 2 schematically shows a data processing system configured for selective touch screen disablement for user interface control of a mobile device. The system includes a host computer 210 with memory and at least one processor. An operating system 220 can execute in the host computer 210 and support the operation of computer program 230. A selective disablement module 300 also can execute in the memory of the computer 210 and can be coupled to the computer program 230.

The module 300 includes program code enabled upon execution in the memory of the computer to define a portion of a display of the computer 210 that includes one or more user interface controls of the computer program 230. The defined portion is stored in the memory of the computer 210 and different user interface events are received in connection with the display of the computer 210. To the extent that the events are received in connection with the defined portion, the program code of the module 300 does not permit further processing of the events in the computer program 230. However, the inhibition of processing of the events based upon the defined portion is lifted in response to a determination by facial recognition system 240 that an end user originating the events is authorized. Conversely, the inhibition of processing of events based upon the defined portion is imposed in response to a determination by the facial recognition system 240 that the end user originating the events is not authorized.

In even yet further illustration of the operation of the selective disablement module, FIG. 3 is a flow chart illustrating a process for selective touch screen disablement for user interface control of a mobile device. Beginning in block 310, an exclusion portion defined for a display of a computer is loaded into memory and, thereafter, in block 320 an event is received in connection with the display. In block 330, the coordinates of the event are determined. In decision block 340, if the coordinates are determined to be within the exclusion portion, in block 350 the event is ignored. Otherwise, the event is passed to the application for further processing by the application.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for selective screen disablement for user interface control of a mobile device, the method comprising:
defining a portion of a display screen of a computer in memory of the computer, the portion including one or more user interface controls of a computer program executing in the memory of the computer;
receiving a user interface event in the display screen in connection with one of the user interface controls of the computer program;
determining whether or not the event is associated with the defined portion; and,
inhibiting processing of the event in the computer program with respect to a corresponding one of the user interface controls in response to a determination that the event is associated with the defined portion.

2. The method of claim 1, wherein the display screen is a touch screen display.

3. The method of claim 1, wherein the inhibition of processing is disabled for an authorized end user.

4. The method of claim 1, wherein the inhibition of processing is disabled for an authorized end user determined based upon facial recognition of the end user.

5. The method of claim 1, wherein the inhibition of processing is enabled for an unauthorized end user.

6. A data processing system configured for selective screen disablement for user interface control of a mobile device, the system comprising:
a computer with memory and at least one processor;
a display screen coupled to the computer;
a computer program executing in the memory of the computer; and,
a selective screen disablement module executing in the memory of the computer and comprising program code enabled to defining a portion of the display screen including one or more user interface controls of the computer program, to receive a user interface event in the display screen in connection with one of the user interface controls of the computer program, to determine whether or not the event is associated with the defined portion, and to inhibit processing of the event in the computer program with respect to a corresponding one of the user interface controls in response to a determination that the event is associated with the defined portion.

7. The system of claim 6, wherein the display screen is a touch screen display.

8. The system of claim 6, wherein the inhibition of processing is disabled for an authorized end user.

9. The system of claim 1, wherein the inhibition of processing is disabled for an authorized end user determined based upon facial recognition of the end user.

10. The system of claim 1, wherein the inhibition of processing is enabled for an unauthorized end user.

11. A computer program product for selective screen disablement for user interface control of a mobile device, the computer program product comprising a computer readable storage medium having program instructions embodied therewith, the program instructions executable by a device to cause the device to perform a method comprising:
defining a portion of a display screen of a computer in memory of the computer, the portion including one or more user interface controls of a computer program executing in the memory of the computer;
receiving a user interface event in the display screen in connection with one of the user interface controls of the computer program;
determining whether or not the event is associated with the defined portion; and,
inhibiting processing of the event in the computer program with respect to a corresponding one of the user interface controls in response to a determination that the event is associated with the defined portion.

12. The computer program product of claim 11, wherein the display screen is a touch screen display.

13. The computer program product of claim 11, wherein the inhibition of processing is disabled for an authorized end user.

14. The computer program product of claim 11, wherein the inhibition of processing is disabled for an authorized end user determined based upon facial recognition of the end user.

15. The computer program product of claim 11, wherein the inhibition of processing is enabled for an unauthorized end user.
